(19) United States
(12) Patent Application Publication
(10) Pub. No.: US 2019/0361193 A1
(43) Pub. Date: Nov. 28, 2019

(54) LENS MODULE AND METHOD FOR ASSEMBLING THE SAME

(71) Applicants: TRIPLE WIN TECHNOLOGY(SHENZHEN) CO.LTD., Shenzhen (CN); HON HAI PRECISION INDUSTRY CO., LTD., New Taipei (TW)

(72) Inventors: LONG-FEI ZHANG, Shenzhen (CN); SHIN-WEN CHEN, New Taipei (TW); KUN LI, Shenzhen (CN); SHUAI-PENG LI, Shenzhen (CN)

(21) Appl. No.: 15/995,291

(22) Filed: Jun. 1, 2018

(30) Foreign Application Priority Data
May 22, 2018 (CN) 201810494261.1

(51) Int. Cl. G02B 7/02; G02B 27/09; G02B 5/20; H04N 5/225

(52) U.S. Cl. CPC G02B 7/02; G02B 27/0955; H04N 5/2254; H04N 5/2253; G02B 5/20

(57) ABSTRACT

A lens module to exclude stray and internally-reflected light and thereby avoid flares and stains in images includes a lens unit, a circuit board, an image sensor, an optical filter, and a hollow mounting frame. The lens unit includes hollow lens holder and lens therein. The image sensor is connected onto the circuit board. The optical filter is at one side of the mounting frame, opposing side is fixed to the circuit board to enclose the image sensor. A light blocking layer is formed on four sides of a surface of the optical filter facing away from the image sensor. A structurally-significant dustproof adhesive layer fills a first gap between the mounting frame and the optical filter and a second gap between the mounting frame and the shielding layer. The lens holder is connected to the mounting frame.

### FIELD

The subject matter relates to imaging devices.

### BACKGROUND

A lens module comprises an image sensor glued onto a circuit board, a hollow mounting frame also glued onto the circuit board and surrounding the image sensor, an optical filter glued onto the mounting frame and positioned above the image sensor, and a lens unit glued onto the mounting frame. When in operation, metallic wires of the image sensor and electronic components surrounding the image sensor may reflect incoming light. The reflected light may then arrive at the image sensor to form images. Thus, flares or stains may appear in images lowering the imaging quality.

Therefore, there is room for improvement in the art.

### BRIEF DESCRIPTION OF THE DRAWINGS

Implementations of the present technology will now be described, by way of example only, with reference to the attached figures.

FIG. 1 is a flowchart of an embodiment of a method for assembling a lens module.

FIG. 2 is a diagrammatic view of an embodiment of a lens module.

FIG. 3 is an exploded diagram of the lens module of FIG. 2.

FIG. 4 is a cross-sectional view taken along line IV-IV of FIG. 2.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

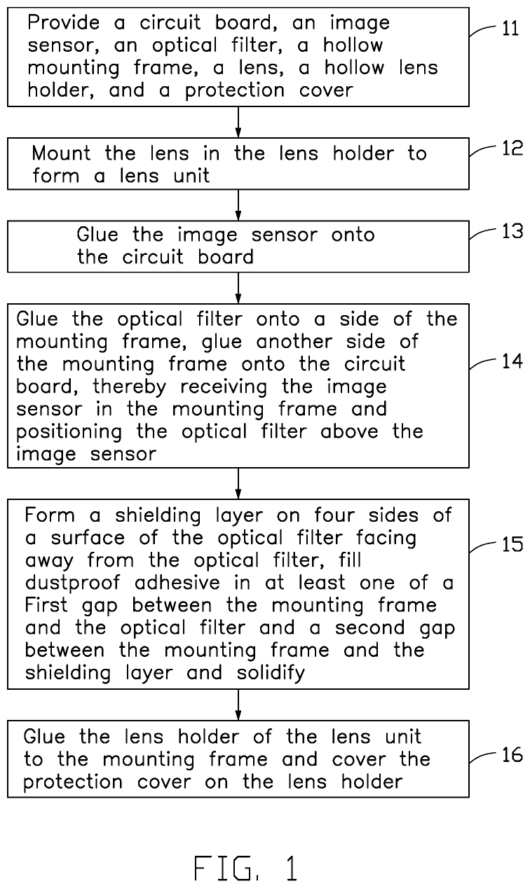

FIG. 1 illustrates an embodiment of a method for assembling a lens module. The method is provided by way of example, as there are a variety of ways to carry out the method. Each block shown in FIG. 1 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 11.

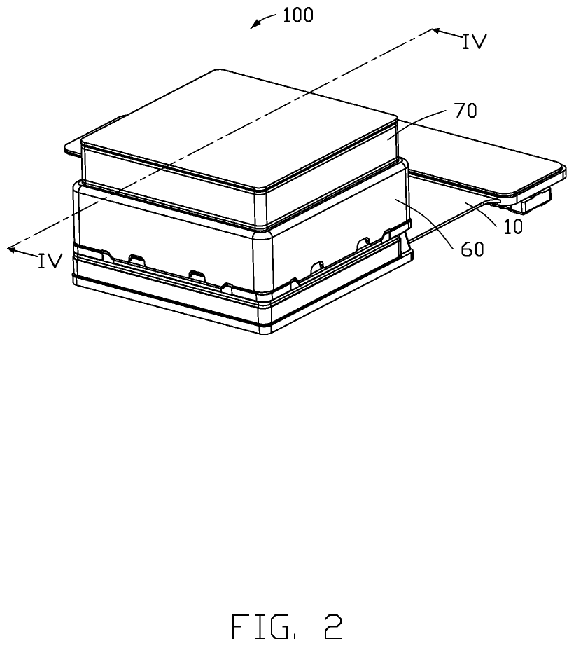

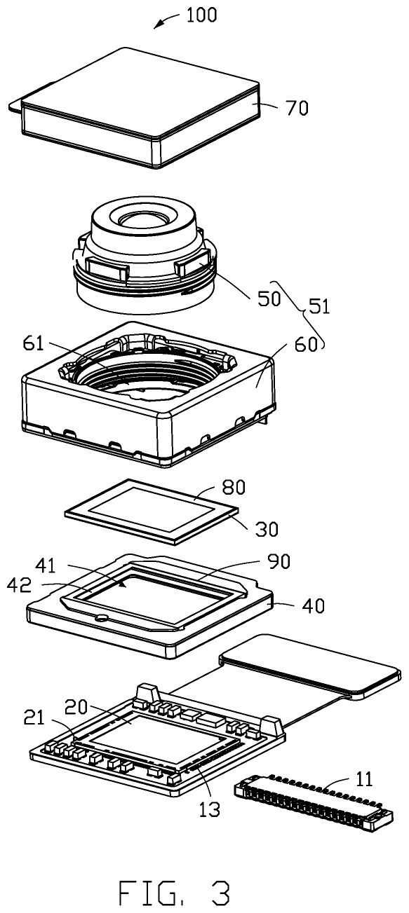

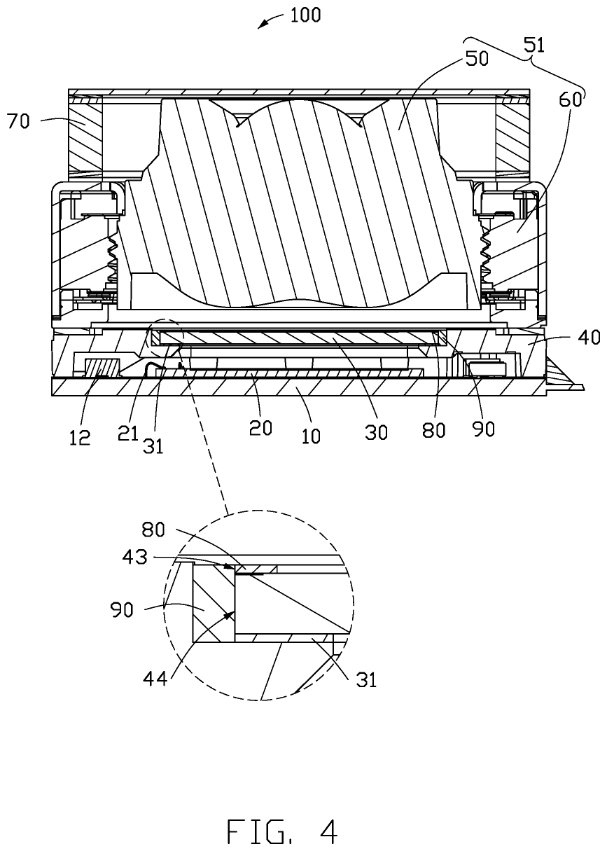

At block 11, referring to FIGS. 2-4, a circuit board 10, an image sensor 20, an optical filter 30, a hollow mounting frame 40, a lens 50, a hollow lens holder 60, and a protection cover 70 are provided.

In an embodiment, the circuit board 10 is a printed circuit board, for example, a rigid board, a flexible board, or a rigid-flexible board. The circuit board 10 has a connector 11 on one surface, and electronic components 12 and gold fingers 13 on another opposite surface. The circuit board 10 can support the electronic components 12 and provide connections for the electronic components 12.

In an embodiment, the image sensor 20 can be a Complementary Metal Oxide Semiconductor (CMOS) sensor or a Charge Coupled Device (CCD) sensor.

In an embodiment, the mounting frame 40 is substantially square, and defines a receiving hole 41. A width of the receiving hole 42 is greater than a width of the image sensor 20.

In an embodiment, the lens 50 can be made of resin. The lens holder 60 can be a voice coil motor (VCM), and comprises a through hole 61.

At block 12, the lens 50 is mounted in the lens holder 60 to form a lens unit 51.

In an embodiment, the lens 50 is mounted in the through hole 61 of the lens holder 60.

At block 13, the image sensor 20 is glued onto the circuit board 10.

In an embodiment, the image sensor 20 is glued onto the surface of the circuit board 10 having the electronic components 12 and the gold fingers 13.

In an embodiment, the gold fingers 13 are positioned around the image sensor 20. A surface of the image sensor 20 facing away from the circuit board 10 has metallic wires 21. The metallic wires 21 match and connect to the gold fingers 13. The metallic wires 21 can be made of metal having good conductivity, such as gold (Au).

At block 14, the optical filter 30 is glued onto a side of the mounting frame 40. The opposite side of the mounting frame 40 is glued onto the circuit board 10, thereby the image sensor 20 is received in the receiving hole 41 and the optical filter 30 is positioned above the image sensor 20. The optical filter 30 has a surface 31 facing away from the image sensor 20.

In an embodiment, when the mounting frame 40 is glued onto the circuit board 10, the electronic components 12 and the gold fingers 13 are positioned inside the mounting frame 40.

In an embodiment, the mounting frame 40 is recessed around the receiving hole 41 to form a stepped portion 42. The optical filter 30 is glued onto the stepped portion 42 with adhesive layer 31, causing the optical filter 30 to be flush with the mounting frame 40. The adhesive layer 31 can be made of optical clear adhesive (OCA).

At block 15, a light-blocking layer (shielding layer) 80 is formed on four sides of the surface 31 of the optical filter 30. At least one of a first gap 44 between the mounting frame 40 and the optical filter 30 and a second gap 43 between the mounting frame 40 and the shielding layer 80 is infilled with dustproof adhesive. The dustproof adhesive is further solidified to form a dustproof adhesive layer 90.

In an embodiment, the shielding layer 80 is formed by printing ink on the surface 31. The edges of the shielding layer 80 are aligned with the edges of the optical filter 30.

In an embodiment, the dustproof adhesive can be dustproof silica gel or dustproof rubber.

At block 16, the lens holder 60 of the lens unit 51 is glued onto the mounting frame 40 to position the lens 50 above the image sensor 20. The protection cover 70 covers the lens holder 60, thereby obtaining the lens module 100.

FIGS. 2 to 4 illustrate an embodiment of a lens module 100. The lens module 100 can be used in an electronic device, such as a smart phone, a tablet computer, or a personal digital assistant (PDA). The lens module 100 comprises a circuit board 10, an image sensor 20, an optical filter 30, a hollow mounting frame 40, a lens unit 51, and a protection cover 70.

The lens unit 51 comprises a lens 50 and a lens holder 60. The lens 50 is mounted in the lens holder 60.

The image sensor 20 is glued onto the circuit board 10. The optical filter 30 is glued onto a side of the mounting frame 40. The opposite side of the mounting frame 40 is glued to the circuit board 10, thereby receiving the image sensor 20 in the receiving hole 41 and positioning the optical filter 30 above the image sensor 20. The optical filter 30 has a surface 31 facing away from the image sensor 20. A shielding layer 80 is formed on four sides of the surface 31 of the optical filter 30. A dustproof adhesive layer 90 infills at least one of a first gap 44 between the mounting frame 40 and the optical filter 30 and a second gap 43 between the mounting frame 40 and the shielding layer 80.

The lens holder 60 of the lens unit 51 is glued onto the mounting frame 40.

The protection cover 70 covers the lens holder 60.

When in use, the optical filter 30 removes infrared light from the light beams passing through the lens 50. The image sensor 20 converts the light beams to electrical signals, and outputs the electrical signals to the circuit board 10. The circuit board 10 processes the electrical signals to form images. The lens module 100 can be mounted to other components (not shown) of the electronic device through the connector 11.

With the above configuration, the shielding layer 80 can block a portion of the incoming light beams, thereby preventing reflections from the mounting frame 40 to the image sensor 20. Thus, flares or stains in the image can be avoided. Furthermore, the dustproof adhesive layer 90 prevents the entry of light through the first gap 44 between the mounting frame 40 and the optical filter 30 and the second gap 43 between the mounting frame 40 and the shielding layer 80, thus no such light can arrive at the image sensor 20. Thus, flares or stains caused thereby can be avoided. In the absence of the dustproof adhesive layer 90, the gluing area of the optical filter 30 depends on the surface area of the adhesive layer 31. The addition of the dustproof adhesive layer 90 increases the available gluing area of the optical filter 30, thereby improving the gluing strength between the optical filter 30 and the mounting frame 40. Finally, the dustproof adhesive layer 90 inherently prevents dust and other contaminants (such as fragments generated by friction between the lens 50 and the lens holder 60) falling on and polluting the image sensor 20.

Depending on the embodiment, certain of the steps of method hereinbefore described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A method for assembling a lens module, comprising:
providing a circuit board, an image sensor, an optical filter, a hollow mounting frame, a lens, and a hollow lens holder;
mounting the lens in the lens holder to form a lens unit;
connecting the image sensor onto the circuit board;
connecting the optical filter onto a side of the mounting frame, connecting an opposite side of the mounting frame to the circuit board, thereby receiving the image sensor in the mounting frame and positioning the optical filter above the image sensor, the optical filter having a surface facing away from the image sensor;
forming a shielding layer on four sides of the surface of the optical filter;
filling dustproof adhesive in at least one of a first gap between the mounting frame and the optical filter and a second gap between the mounting frame and the shielding layer, solidifying the dustproof adhesive to form a dustproof adhesive layer; and
connecting the lens holder of the lens unit onto the mounting frame to position the lens above the image sensor.

2. The method of claim 1, wherein the shielding layer is formed by printing ink on the surface of the optical filter.

3. The method of claim 1, wherein edges of the shielding layer are aligned with edges of the optical filter.

4. The method of claim 1, wherein the mounting frame defines a receiving hole for receiving the image sensor, the mounting frame is recessed around the receiving hole to form a stepped portion, the optical filter is glued onto the stepped portion with an adhesive layer, causing the optical filter to be flush with the mounting frame.

5. The method of claim 1, wherein the circuit board has electronic components and gold fingers on a surface, the image sensor is connected onto the surface of the circuit board having the electronic components and the gold fingers, the gold fingers are positioned around the image sensor.

6. The method of claim 5, wherein a surface of the image sensor facing away from the circuit board has metallic wires, the metallic wires are electrically connected to the gold fingers.

7. The method of claim 1, wherein the lens holder is a voice coil motor.

8. A lens module comprising:
a lens unit comprises a hollow lens holder and a lens mounted in the lens holder;
a circuit board;
an image sensor connected onto the circuit board;
an optical filter;
a hollow mounting frame, the optical filter connected to a side of the mounting frame, an opposite side of the mounting frame connected to the circuit board, thereby receiving the image sensor in the mounting frame and positioning the optical filter above the image sensor, the optical filter having a surface facing away from the image sensor;
a shielding layer formed on four sides of the surface of the optical filter;
a dustproof adhesive layer filling in at least one of a first gap between the mounting frame and the optical filter and a second gap between the mounting frame and the shielding layer, the lens holder of the lens unit connected to the mounting frame to position the lens above the image sensor.

9. The lens module of claim 8, wherein the shielding layer is made of printing ink.

10. The lens module of claim 8, wherein edges of the shielding layer are aligned with edges of the optical filter.

11. The lens module of claim 8, wherein the mounting frame defines a receiving hole for receiving the image sensor, the mounting frame is recessed around the receiving hole to form a stepped portion, the optical filter is glued onto the stepped portion with an adhesive layer, causing the optical filter to be flush with the mounting frame.

12. The lens module of claim 8, wherein the circuit board has electronic components and gold fingers on a surface, the image sensor is connected onto the surface of the circuit board having the electronic components and the gold fingers, the gold fingers are positioned around the image sensor.

13. The lens module of claim 12, wherein a surface of the image sensor facing away from the circuit board has metallic wires, the metallic wires are electrically connected to the gold fingers.
